(19) United States
(12) Patent Application Publication
(10) Pub. No.: US 2004/0139252 A1
(43) Pub. Date: Jul. 15, 2004

(54) Removable storage medium

(76) Inventors: Gerard Sinpraseuth, Paris (FR); Eric Medioni, Rueil-Malmaison (FR)

Correspondence Address: IP DEPARTMENT OF PIPER RUDNICK LLP, ONE LIBERTY PLACE, SUITE 4900, 1650 MARKET ST, PHILADELPHIA, PA, 19103, US

(21) Appl. No.: 10/681,438

(22) Filed: Oct. 8, 2003

Related U.S. Application Data
(63) Continuation of application No. PCT/FR02/01291, filed on Apr. 12, 2002.

(30) Foreign Application Priority Data
Apr. 12, 2001 (FR) FR 01/05051

(51) Int. Cl. G06F 13/12

(52) U.S. Cl. 710/62

(57) ABSTRACT

A removable information storage medium including at least one computer program for displaying and processing information recorded on the storage medium and information recorded on a server accessible via a telecommunication network, wherein the medium can be operated by host equipment comprising a reader; at least one specific operating system independent of the operating system of the host equipment, the specific operating system replacing on a temporary basis the operating system of the host equipment and including an integration of computer resources for operating the computer program, an integration of drivers controlling peripheral network access devices and peripheral input/output devices for a user interface, the specific operating system not operating drivers of the host equipment, nor modifying any system, any program nor any driver of the host equipment, nor an automatic recognition and activation system upon startup of the peripheral devices launched on the host equipment and required for host equipment; means for implementing upon detection by the host equipment of the presence of the storage medium in the reader, at least the startup and the loading of the specific operating system and the drivers launched, the specific operating system starting up from a removable storage medium being autonomous and immutable.

The present invention pertains to the field of recording storage media and notably of the removable CD-ROM type.

Known in the state of the art is an American patent describing a method intended for the initialization of a computer from a removable disk unit, and suitable for an environment in which said removable disk unit is configured as the hard disk unit of the computer. This removable disk unit reacts to the self-test state upon startup as if it contained a data storage medium irrespective of whether or not there is a storage medium in the unit. Thus, said removable disk unit is recognized by the basic input-output system (BIOS). Moreover, a replacement master initialization register is provided to the computer from a read-only memory contained in the removable disk unit in response to a query regarding the master initialization register of the information storage medium.

Generally speaking, it is known to make removable CD disks containing a complete or partial operating system enabling startup of a computer.

Such disks contain in the state of the art the operating system identical to that installed on the startup hard disk, driving the various computer resources of the host equipment. They therefore present risks of inopportune modification of the computer resources of the host equipment, notably by means of computer viruses.

The goal of the present invention is to propose a storage medium enabling startup on an independent operating system and operation of applications resident on the storage medium or on an external storage medium accessible via a network, without affecting any resource of the host equipment.

For this purpose, the invention pertains according to its most general sense to a removable information storage medium according to claim 1.

This storage medium comprises at least one computer application launched for the display and processing of information recorded on said storage medium and information recorded on a server accessible via a telecommunication network, said storage medium being such that it can be operated by host equipment comprising a suitable reader; this storage medium being characterized in that it furthermore comprises at least one specific operating system independent of the operating system of the host equipment, this specific operating system replacing on a temporary basis the operating system of the host equipment and comprising the integrality of the computer resources for the operating of said launched application, as well as the integrality of the drivers for controlling the peripheral network access devices, as well as the peripheral input/output devices for the user interface [keyboard, mouse, screen, printer, etc.], the specific operating system not operating the drivers of the host equipment, nor modifying any system, any program nor any driver of the host equipment, as well as an automatic recognition and activation system upon startup of the peripheral devices launched on the host equipment and required for its operation, the storage medium comprising moreover a means for implementing upon detection by the host equipment of the presence of said storage medium in the reader, at least the startup and the loading of the specific operating system and the drivers launched, the specific operating system starting up from a removable storage medium being autonomous and immutable.

Thus, the autonomous operating system does not require the presence and the protection of a hardware or software configuration file of the host equipment and consequently its operation cannot be altered by the failure of a system configuration file.

Moreover, this specific operating system does not replace definitively the operating system of the host equipment (the host equipment returning to its initial configuration when it is restarted, either by removing the removable storage medium or by selecting an option on a startup menu).

Moreover, the specific operating system that launches the removable storage medium retains the assurance of being autonomous and immutable (in relation to the operating system of the host equipment); i.e., the specific operating system is not modifiable as such; however, it can be associated with modifiable elements. The drivers and programs comprising the operating system are called-up depending on the user's requirements; supplementary drivers and programs can be loaded via a telecommunication network and be activated without having to restart the host equipment nor modify the structure of the specific operating system.

According to a first variant, the storage medium presents a rewritable zone for the personalization of the information and a non-rewritable zone for recording specific computer resources.

According to a second variant, the storage medium is an optical disk of the CD type.

According to a third variant, the storage medium is a non-volatile memory.

According to a fourth variant, the storage medium is a magnetoresistive memory.

According to a fifth variant, the storage medium is a semiconductor memory.

The real time operating system advantageously comprises a program for the management of the allocation of the processor time of the host equipment as well as the allocation and regeneration of tasks.

The size of the core of the operating system is preferably smaller than 50 kilo-octets.

According to a preferred variant, the information storage medium deactivates the operation of and access to the peripheral storage devices of the host equipment as well as the opening of the communication gateways with the exception of the communication gateway(s) controlled by the launched resources, these latter being reinitialized by the loading of the specific operating system.

The computer resources preferably comprise an Internet navigator not recording data stemming from the network exclusively in the RAM memory of the host equipment or in the rewritable zone of the storage medium, to the exclusion of the other memories of the host equipment.

According to another variant, the storage medium comprises a filter controlling the data recorded in the rewritable zone.

It advantageously includes personalization information in a non-rewritable zone for the generation of a private key by an algorithm recorded in the non-rewritable zone and taking into account said personalization zone and an information element [paraphrase] captured by the user of the host equipment.

According to another variant, it comprises means for recording data in the CMOS memory of the host equipment.

According to still another variant, it comprises means for implementing a partition of the hard disk of the host equipment and for controlling the reading and recording of data in said partition of the hard disk solely to the exclusion of the other partitions of the hard disk.

According to a particular mode of implementation, the storage medium comprises means for controlling the reading and recording of data in a memory of the host equipment controlled by a specific driver.

The invention also pertains to a system comprising a master removable information storage medium remarkable in that it moreover comprises at least one other slave information storage medium comprising a navigator and the protocols for access to a communication network by a host equipment to another operating equipment, the slave information storage medium not comprising means for autonomous operation.

The invention also pertains to a system comprising a removable information storage medium remarkable in that it incorporates a process that can limit or augment access to the information and services that it contains in time and/or in number of accesses.

The invention also pertains to a system comprising a removable information storage medium remarkable in that it incorporates multiple specific operating systems addressing multiple distinct computer processor and physical platforms, allowing it to start up on each of said distinct processor and physical platforms.

Better understanding of the present invention will be obtained from the description below of a nonlimitative example of implementation.

According to an example of implementation, the storage medium according to the invention is constituted by a CD-ROM comprising a startup (“boot”) function recorded on the storage medium. Upon startup, this program detects the physical configuration of the host computer on which it has just booted and loads in the RAM memory of the host computer its own operating system, which makes it totally independent of the operating system of the host equipment.

Once a user has booted in this new environment, he has access to services such as:

Dialing of a preconfigured telephone number of an access provider by a single click of the mouse; once the computer is connected a navigator is launched and provides access to a determined Internet site.

A maximum of software components are launched to provide access to:

Flash sequences, Shockwave, RealPlayer, MP3, Media Player, ActiveX, QuickTime, WAP, SMIL, etc.

The navigator is compatible: HTML 4, Java, Java Script, Javaservlets, CSS, XML, DHTML, SSL with 128-bit encryption (secure banking transactions), Net2Phone (voice on IP), NetMeeting, H320 and H323 (videoconferencing), T120 (sharing a whiteboard), provide access to news groups, chat with ICQ compatibility, AIM, Microsoft Messenger.

The messaging service is compatible: POP3, IMAP4, Webmail, identification by PKI key, etc.

Reading files: jpeg, tiff, giff, svg, png, bmp, pdf, eps, etc.

FTP transfer function so that the user can protect his documents created on the disk of his Internet Access Provider (virtual disk function).

Text processing.

Calendar.

Audio CD reader, MP3 reader.

Euro calculator.

Calorie calculator.

Multiple IAP accounts are registered and offered to the user such that in the case of saturation of an IAP's network, he can immediately transfer to another IAP.

The goal is to launch a maximum of software components so that the user can access very simply a very large number of service without having to install any supplementary software.

The major benefits of this invention are to provide the user with access to all of the services mentioned above from any computer with an unprecedented level of security: no virus can reach the machine serving as the connection to the network; no information can be pirated or damaged on the workstation that was used for the connection.

An autonomous operating system that can be booted from a CD-ROM of a size reduced to that of a card, adapted to an RTC connection (telephone line) or LAN connection (network) under a PC platform.

Upon restarting of the PC after introduction of the CD, a startup screen informs the user that his computer is in the process of booting on the CD.

During startup, the operating system launched lists the modem and the peripherals contained in the PC. If it is unable to find exactly the right driver, it uses a compatible generic driver.

The operating system displays an “office” adapted to the resolution of the PC workstation screen; it provides access to the applications contained in an array of tasks and displaces the position of the user in relation to 9 virtual screens which compose an equal number of autonomous work spaces.

One screen gives the user a choice between an RTC or LAN connection which he must validate.

After having validated an RTC connection, a dialer displays a list of Internet Access Providers (IAP) from which the user selects and validates. Upon validation, the dialer enters the IAP access number and transmits the following information so as to identify the holder of the IPX card which is connected:

Identifier/User's connection login

Connection password

Telephone number of the IAP for the connection

Primary DNS

Secondary DNS

Domain name

The user has the possibility of configuring his personal account maintained by his IAP in order to have access to his accounting account. The user manually validates the following points:

Identifier/User's connection login

Connection password

Telephone number for the connection

Primary DNS

Secondary DNS

Domain name

User's e-mail address

Message service login

Message service password

SMTP server (transmission of mail)

POP3 server (receipt of mail)

News server (news group)

After the selection has been made, the dialer inputs the IAP number; while the user is waiting, the screen informs him that he will be connected to the Internet shortly.

Once the connection has been established, a navigator is automatically launched to access the startup page of a predefined Internet site.

After having validated a LAN connection, a request is transmitted to the DHCP server which dynamically returns the following parameters:

Dynamic IP address

Subnet mask

Address of the router

Address of the name server

Search domain

If identification of a proxy: return address of the proxy and return of the port number.

The user must manually enter:

His user name

His password

If there is no DHCP server on the network, the user must ask his administrator to provide all of these parameters in order to be connected.

Once the connection has been established, a navigator is automatically launched to access the startup page of a predefined Internet site.

1. Removable information storage medium comprising at least one computer application launched for the display and processing of information recorded on said storage medium and information recorded on a server accessible via a telecommunication network, said storage medium being such that it can be operated by host equipment comprising a suitable reader, characterized in that said storage medium furthermore comprises at least one specific operating system independent of the operating system of the host equipment, this specific operating system replacing on a temporary basis the operating system of the host equipment and comprising the integrality of the computer resources for the operating of said launched application, as well as the integrality of the drivers for controlling the peripheral network access devices, as well as the peripheral input/output devices for the user interface [keyboard, mouse, screen, printer, etc.], the specific operating system not operating the drivers of the host equipment, nor modifying any system, any program nor any driver of the host equipment, as well as an automatic recognition and activation system upon startup of the peripheral devices launched on the host equipment and required for its operation, the storage medium comprising moreover a means for implementing upon detection by the host equipment of the presence of said storage medium in the reader, at least the startup and the loading of the specific operating system and the drivers launched, the specific operating system starting up from a removable storage medium being autonomous and immutable.

2. Removable information storage medium according to claim 1, characterized in that the storage medium presents a rewritable zone for the personalization of the information and a non-rewritable zone for recording specific computer resources.

3. Removable information storage medium according to claim 1 or 2, characterized in that the storage medium is an optical disk of the CD type.

4. Removable information storage medium according to claim 1, characterized in that the storage medium is a non-volatile memory.

5. Removable information storage medium according to claim 1, characterized in that the storage medium is a magnetoresistive memory.

6. Removable information storage medium according to claim 1 or 2, characterized in that the storage medium is a semiconductor memory.

7. Removable information storage medium according to at least one of the preceding claims, characterized in that the real time operating system comprises a program for the management of the allocation of the processor time of the host equipment as well as the allocation and regeneration of tasks.

8. Removable information storage medium according to at least one of claims 1 to 6, characterized in that the size of the core of the operating system is smaller than 50 kilo-octets.

9. Removable information storage medium according to at least one of claims 1 to 6, characterized in that it deactivates the operation of and access to the peripheral storage devices of the host equipment as well as the opening of the communication gateways with the exception of the communication gateway(s) controlled by the launched resources, these latter being reinitialized by the loading of the specific operating system.

10. Removable information storage medium according to at least one of claims 1 to 6, characterized in that the computer resources comprise an Internet navigator not recording data stemming from the network exclusively in the RAM memory of the host equipment or in the rewritable zone of the storage medium, to the exclusion of the other memories of the host equipment.

11. Removable information storage medium according to at least one of the preceding claims, characterized in that it comprises a filter controlling the data recorded in the rewritable zone.

12. Removable information storage according to at least one of the preceding claims, characterized in that it includes personalization information in a non-rewritable zone for the generation of a private key by an algorithm recorded in the non-rewritable zone and taking into account said personalization zone and an information element [paraphrase] captured by the user of the host equipment.

13. Removable information storage according to at least one of the preceding claims, characterized in that it includes personalization information in a non-rewritable zone for the generation of a private key by an algorithm recorded in the server and taking into account said personalization zone and an information element [paraphrase] captured by the user of the host equipment.

14. Removable information storage medium according to at least one of the preceding claims, characterized in that it comprises means for recording data in the CMOS memory of the host equipment.

15. Removable information storage medium according to claim 1, characterized in that it comprises means for implementing a partition of the hard disk of the host equipment and for controlling the reading and recording of data in said partition of the hard disk solely to the exclusion of the other partitions of the hard disk.

16. Removable information storage medium according to claim 1, characterized in that it comprises means for controlling the reading and recording of data in a memory of the host equipment controlled by a specific driver.

17. Removable information storage medium according to claim 1, characterized in that it incorporates means that can limit or augment access to the information and services that it contains in time and/or in number of accesses.

18. Removable information storage medium according to claim 1, characterized in that it incorporates multiple specific operating systems addressing multiple distinct computer processor and physical platforms, allowing it to start up on each of said distinct processor and physical platforms.
